(19) United States
(12) Patent Application Publication
(10) Pub. No.: US 2026/0128888 A1
(43) Pub. Date: May 7, 2026

(54) Enforcing a User-Specific Authorization Policy for Authorizing an Interaction Between Applications Running on a Same Computing Device

(71) Applicant: MOTOROLA SOLUTIONS, INC., CHICAGO, IL (US)

(72) Inventors: RAMU KANDULA, OAK POINT, TX (US); RAAJEEV KUPPA, RICHARDSON, TX (US); RAJENDRA ANTHONY, RICVHARDSON, TX (US)

(21) Appl. No.: 18/935,901

(22) Filed: Nov. 4, 2024

(51) Int. Cl. H04L 9/32; G06F 21/62

(52) U.S. Cl. CPC H04L 9/3213; G06F 21/629; H04L 9/3247; G06F 2221/2141

(57) ABSTRACT

A process for enforcing a user-specific authorization policy for authorizing an interaction between applications running on a same computing device. The policy provisioned at an intent management server identifies intents that the first application is authorized on behalf of a user to accept from a second application running on the computing device. The server receives an intent authorization request from the second application intending to interact with the first application. The request includes a user token associated with a user and information identifying an intent that the second application is intending to invoke with the first application. The server validates the user token by verifying that the user is authorized to access both the first and second applications and provides a response based on the policy to indicate whether the second application is authorized to invoke the intent with the first application.

### BACKGROUND

Computing devices such as smartphones and radios operate through operating systems and applications to manage tasks and provide communication services. Operating systems use messages to facilitate communications between applications installed on a device. For instance, the Android™ operating system relies on messaging objects called “intents” for sending and receiving data, initiating actions, or triggering processes between applications. As an example, a messaging application may use an intent to request a map application to launch a navigation service corresponding to an address displayed on a text message. As another example, the mapping application may use an intent to request the messaging application to send the location of a user with the user's contact stored in the messaging application.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of a computing device shown in FIG. 1 in accordance with some embodiments.

FIG. 3 is a block diagram of an intent management server shown in FIG. 1 in accordance with some embodiments.

FIG. 4 illustrates a flowchart of a process for enforcing a user-specific authorization policy for authorizing an interaction between applications running on a same computing device in accordance with some embodiments.

FIG. 5 is a message flow diagram illustrating the process shown in FIG. 4 in accordance with some embodiments.

FIG. 6 illustrates a flowchart of another process for enforcing a user-specific authorization policy for authorizing an interaction between applications running on a same computing device in accordance with some embodiments.

FIG. 7 is a message flow diagram illustrating the process shown in FIG. 6 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, intents are useful to facilitate seamless communication between applications. However, the information exchanged by means of intents is not secure as it is visible to entities having access to the device's operating system environment. Devices are sometimes shared by multiple users and an application residing on the device may handle data and services for multiple users. For example, a first application running on a particular computing device may share sensitive information about a first user to a second application running on the same computing device by invoking an intent. The second application may store information corresponding to the first user while executing the intent invoked by the first application. In this case, a second user having access to the second application on the same computing device may be able to access the information stored by the second application corresponding to the first user even though the second user is not otherwise authorized to access the information shared corresponding to the user. Accordingly, there is a need for a technological solution that enforces a user-specific authorization policy to authorize interactions between two applications running on the same device.

One embodiment provides a method for enforcing a user-specific authorization policy for authorizing an interaction between applications running on a same computing device. The method comprises provisioning, at an intent management server, a user-specific authorization policy for each respective user from a list of users authorized to access a first application running on a computing device, the user-specific authorization policy identifying one or more allowed intents that the first application is authorized on behalf of the respective user to accept from a second application running on the computing device; receiving, at the intent management server, an intent authorization request from the second application intending to interact with the first application on behalf of a first user from the list of users, the intent authorization request from the second application including an user token associated with the first user and information identifying at least one intent that the second application is intending to invoke with the first application; validating, at the intent management server, the user token received from the second application by verifying that the first user is authorized to access both the first and second applications running on the computing device; and providing, at the intent management server, a response to the intent authorization request based on the user-specific authorization policy provisioned for the first user from the list of users, the response indicating whether the second application running on the computing device is authorized on behalf of the first user to invoke the at least one intent with the first application running on the computing device.

Another embodiment provides a method for enforcing a user-specific authorization policy for authorizing an interaction between applications running on a same computing device. The method comprises: provisioning, at an intent management server, a user-specific authorization policy for each respective user from a list of users authorized to access a first application running on a computing device, the user-specific authorization policy identifying one or more intents that the first application is authorized on behalf of the respective user to invoke with a second application running on the computing device; receiving, at the intent management server, an intent authorization request from the first application intending to interact with the second application on behalf of a first user from the list of users, the intent authorization request from the first application including an user token associated with the first user and information identifying at least one intent selected from the one or more intents that the first application is intending to invoke with the second application; validating, at the intent management server, the user token received from the first application by verifying that the first user is authorized to access both the first and second applications running on the computing device; and providing, at the intent management server, a response to the intent authorization request based on the user-specific authorization policy provisioned for the first user from the list of users, the response indicating whether the first application is authorized on behalf of the first user to invoke the at least one intent with the second application running on the computing device.

A further embodiment provides an intent management server comprising a communications interface, a memory provisioned with a user-specific authorization policy for each respective user from a list of users authorized to access a first application running on a computing device, the user-specific authorization policy identifying one or more allowed intents that the first application is authorized on behalf of the respective user to invoke with or accept from a second application running on the computing device, and an electronic processor communicatively coupled to the communications interface and the memory. The electronic processor is configured to: receive, via the communications interface, an intent authorization request from the second application intending to interact with the first application on behalf of a first user from the list of users, the intent authorization request from the second application including an user token associated with the first user and information identifying at least one intent that the second application is intending to invoke with the first application; validate the user token received from the second application by verifying that the first user is authorized to access both the first and second applications running on the computing device; and provide, via the communications interface, a response to the intent authorization request based on the user-specific authorization policy provisioned for the first user from the list of users, the response indicating whether the second application running on the computing device is authorized on behalf of the first user to invoke the at least one intent with the first application running on the computing device.

Each of the above-mentioned embodiments will be discussed in more detail below, starting with example system and device architectures of the system in which the embodiments may be practiced, followed by an illustration of processing blocks for achieving an improved technical system, method, and device for enforcing a user-specific authorization policy for authorizing an interaction between applications running on a same computing device. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

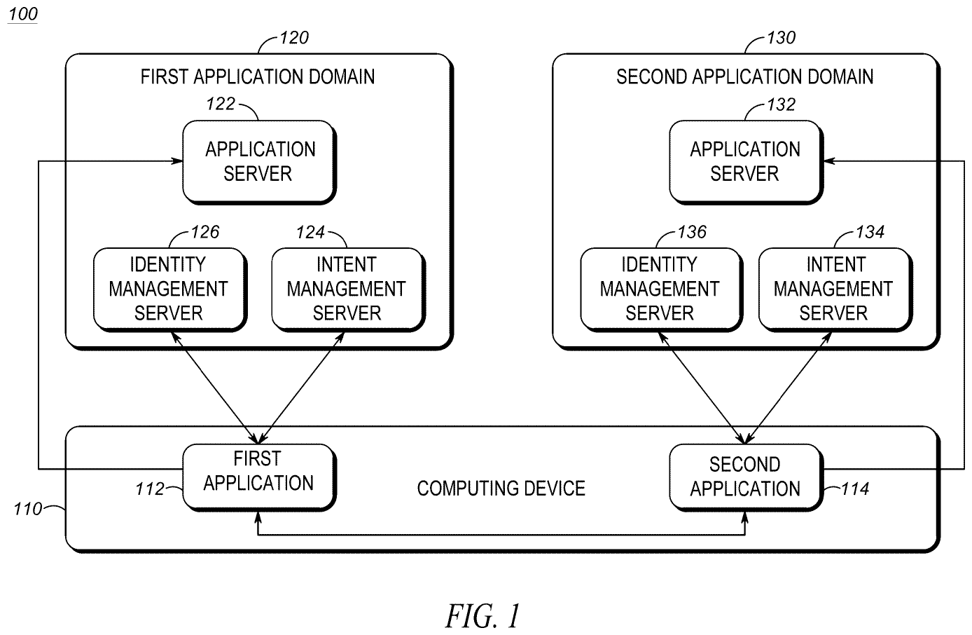

Referring now to the drawings, and in particular FIG. 1, a system 100 is shown including a computing device 110, a first application domain 120, and a second application domain 130. In accordance with some embodiments, the computing device 110 is a mobile computing device including, but not limited to, two-way radios (e.g., land mobile radio or LMR), mobile phones, cellular phones, smart phones, vehicular radios, laptop computers, and tablets. In other embodiments, the computing device 110 may include a fixed computing device such as a desktop computer. In accordance with some embodiments, the computing device 110 refers to a communication device that is shared by multiple users. For instance, in a public-safety environment, officers (e.g., police, fire, emergency medical personnel) frequently use such shared devices. The computing device 110 can be picked by any authorized user from a shared storage location (such as a charging shelf or equipment rack) and used immediately without requiring pre-assignment to a particular user. Each user may log into the device 110 and/or one or more applications provided on the device 110 using their own access credentials (e.g., username and password or forms of authentication, such as biometric data). Although the system is illustrated in FIG. 1 as including a single computing device, the embodiments described herein can be suitably implemented in a number of computing devices where there is a need to enforce user-specific authorization policies for authorizing or controlling interactions between applications running within a computing device.

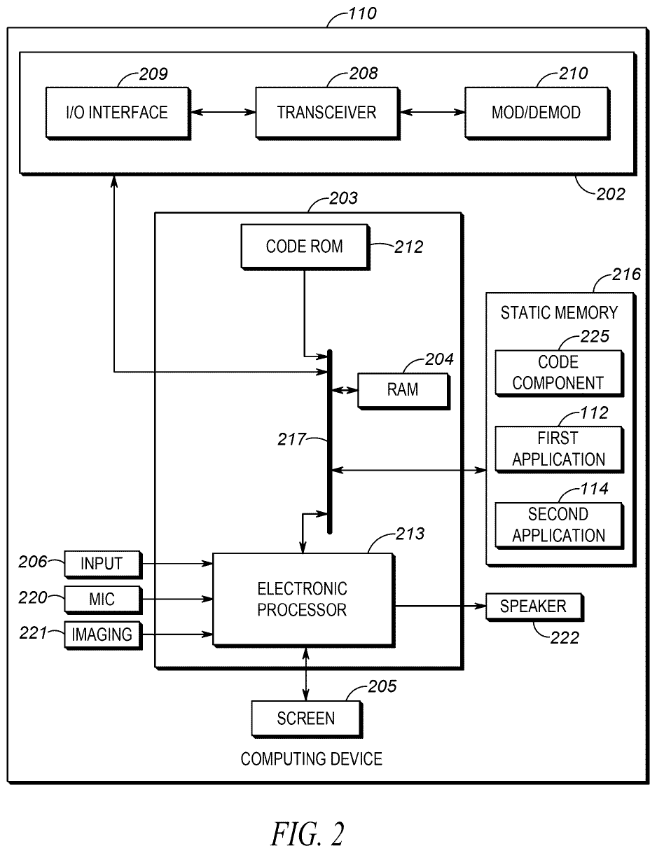

In accordance with embodiments, the computing device 110 includes multiple client-side applications, for example, a first application 112 and a second application 114, running simultaneously on the computing device 110. The applications running on the computing device 110 refers to a software program that is actively being executed by an electronic processor (e.g., electronic processor 213 shown in FIG. 2) of the computing device 110. The applications (or apps) are designed to perform specific tasks or functions, ranging from simple utilities like calculators or text editors to more complex systems such as web browsers, maps, and communications tools. The applications are run utilizing hardware resources such as memory, storage, and processing power available at the computing device 110 to execute instructions, process user inputs, and produce outputs or perform actions. In accordance with embodiments, the applications running on the computing device 110 may refer to a foreground application, where users directly interact with them, or in the background, where tasks are performed on behalf of users without direct user engagement.

In accordance with embodiments, communications or interactions between applications are facilitated by the operating system of the computing device 110 using messaging objects. The embodiments described herein can be implemented for computing devices 110 running any type of operating systems. The Android™ operating system uses messaging objects called “intents” to facilitate interactions between applications. While other operating systems may refer to such messaging objects by different names, the term “intent” is intended herein to broadly cover any messaging object that is used to facilitate interactions between applications, either for sending or receiving data from one application to another application, initiating actions on another application, or triggering processes to run on another application. As an example, a first application 112 running on the computing device 110 may represent a navigation application (e.g., Global Positioning System (GPS) based map application) and a second application 114 running on the computing device may refer to a call/messaging application (e.g., mission-critical push-to-talk (MCPTT) application). In this example, the first application 112 or the navigation application may need to interact with the second application 114 or the call/messaging application to provide location-based updates or route guidance to officers during emergency responses. As another example, the first application 112 running on the computing device 110 may refer to a telemetry application that is configured to detect an emergency condition (e.g., a fall detection event) corresponding to the officer and further interact with the second application 114 or the call/messaging application to automatically report the emergency condition associated with the officer to a dispatcher.

In accordance with embodiments, the first application 112 initiates an interaction with the second application 114 by invoking an intent. The first application 112 may invoke an intent by generating an intent message and transmitting the intent message to the second application 114. The intent message includes parameters that define the action (e.g., share a file, initiate a call, or generate a route guidance) to be performed by the second application 114 and any additional data (e.g., uniform resource locator (URL) or a resource address representing a file path in which the file is stored, or contact to whom the call is to be initiated, or address to which the route guidance is to be generated) required for the second application 114 to execute the action. The intent message from the first application 112 may also further identify a specific application (e.g., the second application 114) that should accept and handle the intent. In accordance with some embodiments, the first application 112 or the second application 114 is authorized to accept an intent invoked by another application based on user-specific authorization policies enforced on behalf of a user using the respective applications. Similarly, in some embodiments, the first application 112 or the second application 114 is authorized to invoke an intent with another application based on user-specific authorization policies enforced on behalf of a user using the respective applications. An application may be referred herein as an originating application when the application intends to invoke an intent with another application. An application may be referred herein as a terminating application when the application is intended to receive, accept, or execute an intent invoked by an originating application.

Assume a scenario where the first application 112 and second application 114 are logged in by different users e.g., a first user and a second user, respectively. When the first application 112 invokes an intent with a second application 114, any information (e.g., location information retrieved corresponding to the first user of the first application 112) included in the intent may be stored at the second application 114 when the second application 114 accepts and executes the intent. In such a scenario, it is possible for the second user of the second application 114 to view information stored by the second application 114 even though the second user may not be otherwise authorized to access such information (e.g., location information) corresponding to the first user. Moreover, a security administrator may want to restrict certain users of one application from sharing data with other applications intentionally or inadvertently or to prevent certain users of one application from being able to trigger unauthorized actions (e.g., launching an application, making a call, or requesting data) via other applications running on the same computing device. To address the above problems, the embodiments described herein provide a user-specific authorization policy to prevent one application, for example, a first application 112 from invoking certain intents (e.g., intents not allowed by the policy) with another application such as a second application 114. The embodiments described herein similarly prevent one application, for example, a first application 112 from accepting certain intents (e.g., intents not allowed by the user-specific authorization policy) from another application such as a second application 114. In addition, the user-specific authorization policy authorizes a first application 112 to invoke an intent with or accept from a second application 114 only when the first and the second applications 112, 114 are logged in by the same user.

The term “logged in” or “signed in” described herein refers to the state where a user has accessed an application (or has accessed the data processed or retrieved by the application) running on a computing device by providing a form of user identity, such as a username and password, biometric data, or an access token. The term “user” described herein refers to any individual or entity that has authenticated access to interact with an application. As an example, the user may be an individual user who has signed in to use the application on their personal or company provided computing device. As another example, the user may refer to a business, organization, or an agency that has the application installed across one or more devices issued to its employees, contractors, representatives, associates, or other users. In this case, the user refers to the entity as a whole while individual interactions may occur through the authorized users using the devices.

The system 100 further includes one or more application domains. In the example shown in FIG. 1, a first application 112 is shown as associated with a first application domain 120 and a second application 114 is shown as associated with a second application domain 130. The application domains refer to a logically defined environment or framework comprising a set of related services, resources, and operational protocols designed to provide users with secure access to applications, manage user identities, and protect sensitive data from being passed between applications. In accordance with some embodiments, the first application domain 120 associated with the first application 112 includes an application server 122, an intent management server 124, and an identity management (IDM) server 126. The second application domain 130 associated with the second application 114 similarly includes an application server 132, an intent management server 134, and an identity management (IDM) server 136. While FIG. 1 shows each application as being associated with a separate application domain, in one embodiment, a single application domain may be provided to support multiple applications (e.g., first and second applications 112, 114) running at a computing device 110.

The application servers 122, 132 may each comprise a server (e.g., an email server, database server, proprietary server, web server, or the like where access to applications is permitted only upon verifying user identity) that gives access to one of any number of applications. The application servers 122, 132 each host, manage, and execute the first application 112 and second applications 114, respectively. The application servers 122, 132 also provide services and support the operation and functionality of the first application 112 and second application 114, respectively. The application servers 122, 132 may serve as a middleware platform that bridges a client device such as the computing device 110 running the respective first and second applications 112, 114 with backend resources (not shown) like database, storage, and other services. The application servers 122, 132 may each be either implemented on a single server or in a distributed environment, with software components running across multiple physical or virtual machines and may communicate with other servers using standard network protocols.

The intent management servers 124, 134 each include a computing platform that is configured to authorize interactions between applications running on the same computing device 110. The intent management server 124 associated with the first application domain 120 is provisioned with a user-specific authorization policy for each respective user who is authorized to use the first application 112 running on the computing devsice. For example, the user-specific authorization policy provisioned for a first user (e.g., a user authorized to use the first application 112) at the intent management server 124 identifies one or more allowed intents that the first application 112 is authorized on behalf of the first user to accept from another application, such as the second application 114 running on the computing device 110. The user-specific authorization policy provisioned for the first user at the intent management server 124 may also identify one or more allowed intents that the first application 112 is authorized on behalf of the first user to invoke with another application, such as the second application 114 running on the same computing device 110. The user-specific authorization policy may also alternatively identify one or more restricted intents that the first application 112 is not authorized on behalf of a particular user to either accept from another application or to invoke with another application. The intent management server 134 associated with the second application domain 130 may be similarly provisioned with a user-specific authorization policy for each respective user who is authorized to use the second application 114 running on the computing device 110. For example, the user-specific authorization policy provisioned for a second user (e.g., a user authorized to use the second application 114) at the intent management server 134 identifies one or more allowed intents that the second application 114 is authorized on behalf of the second user to accept from another application, such as the first application 112 running on the same computing device 110. The user-specific authorization policy provisioned for the second user at the intent management server 134 may also identify one or more allowed intents that the second application is authorized on behalf of the second user to invoke with another application, such as the first application 112 running on the computing device 110. The user-specific authorization policy may also alternatively identify one or more restricted intents that the second application 114 is not authorized on behalf of a particular user to either accept from another application or to invoke with another application. While FIG. 1 shows both the first and second application domains 120, 130 as including a separate intent management server, in one embodiment, the second application domain 130 may not include an intent management server and that, in this embodiment, the second application 114 may be authorized, by default (i.e., without user-specific authorization policies), to invoke or accept any intent. In this embodiment, however, the intent management server 124 associated with the first application domain 120 may still enforce user-specific authorization policies to particularly authorize or restrict (i) intents that can be invoked by the first application 112, for example, toward one or more other applications such as the second application 114 running on the computing device 110 or (ii) intents that can be accepted by the first application 112, for example, from one or more other applications such as the second application 114 running on the computing device 110. In other words, in this embodiment, the intent management server 124 serving the first application domain 120 acts as a gatekeeper for the first application 112 to determine whether a certain intent can be accepted from the second application 114 or invoked by the first application 112 with the second application 114 regardless of whether the second application 114 was restricted (based on a user-specific authorization policy) from accepting the certain intent invoked by the first application 112 or invoking the certain intent towards the first application 112. In another embodiment, a single intent management server may be provided as a gatekeeper for multiple applications. For example, in this embodiment, a single intent management server is provisioned with user-specific authorization policies for each respective user authorized to use the first and second applications 112, 114 to authorize or control the intents that can be invoked by or accepted by first or second applications 112, 114.

The identity management servers 126, 136 each include a computing platform that respectively enables a user to access computer programs, applications, information and services hosted by the first application domain 120 and the second application domain 130, via the computing device 110. The identity management server 126, 136 is preferably an authentication server equipped with Security Assertion Markup Language (SAML), OAuth, OpenID connect, or other identity-management protocols configured for performing user authentication. The identity management server 126, 136 is sometimes referred to as an authentication server. The identity management server 126, 136 stores and manages identity-related information, such as usernames, passwords, biometric data, and access credentials. For example, when a user attempts to log into a first application 112, the identity management server 126 serving the first application 112 verifies the login credentials provided by the user. The identity management server 126 may also optionally check the user roles, permissions, and access policies to determine portions of the first application 112 the user is allowed to access. After successful authentication and authorization of the user, the identity management server 126 allows the user to access the functionalities provided by the first application 112. The identity management server 136 may similarly verify login credentials of a user attempting to log into the second application 114 before providing access to functionalities provided by the second application 114. In accordance with some embodiments, the intent management server 124 associated with the first application domain 120 obtains the identity of a particular user authorized to access the first application 112 from the identity management server 126. The intent management server 124 uses the identity to retrieve a user-specific authorization policy associated with the particular user. The retrieved user-specific authorization policy is then used by the intent management server 124 to identify one or more allowed intents that the first application 112 is authorized to invoke with or accept from another application on behalf of the particular user authorized to access the first application 112. Similarly, the intent management server 134 associated with the second application domain 130 obtains the identity of a particular user authorized to access the second application 114 from the identity management server 136. The intent management server 134 uses the identity to retrieve a user-specific authorization policy associated with the particular user authorized to access the second application 114. The retrieved user-specific authorization policy is then used by the intent management server 134 to identify one or more allowed intents that the second application 114 is authorized to invoke with or accept from another application on behalf of the particular user authorized to access the second application.

The computing device 110 may communicate with different entities (i.e., application servers 122, 132, intent management servers 124, 134, and identity management servers 126, 136) associated with the first and second application domains 120, 130 via one or more communication networks (not shown). The communication networks may be implemented using a wide area network, such as the Internet, a local area network, such as a Wi-Fi network, and personal area or near-field networks, for example a Bluetooth™ network. Portions of the communications network may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof.

FIG. 2 is an example functional block diagram of a computing device 110 operating within the system 100 in accordance with some embodiments. The computing device 110 may be embodied in computing devices not illustrated in FIG. 1, and/or may be a distributed computing device across two or more of the foregoing (or multiple of a same type of one of the foregoing) and linked via a wired and/or wireless communication link(s). While FIG. 2 represents a computing device 110 described above with respect to FIG. 1, the computing device 110 may include fewer or additional components in configurations different from that illustrated in FIG. 2.

As shown in FIG. 2, the computing device 110 includes a communications interface 202 coupled to a common data and address bus 217 of a processing unit 203. The communications interface 202 sends and receives data to and from other devices in the system 100. The computing device 110 may also include one or more input devices (for example, keypad, pointing device, touch-sensitive surface, button, a microphone 220, an imaging device 221, and/or another input device 206) and an electronic display screen 205 (which, in some embodiments, may be a touch screen and thus also acts as an input device), each coupled to be in communication with the processing unit 203.

The communications interface 202 may include one or more wired and/or wireless input/output (I/O) interfaces 209 that are configurable to communicate with other devices in the system 100. For example, the communications interface 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11 a, 802.11 b, 802.11g), an LTE transceiver, a WiMAX transceiver perhaps operating in accordance with an IEEE 802.16 standard, and/or another similar type of wireless transceiver configurable to communicate via a wireless radio network. The communications interface 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The input 206 may include an alphanumeric physical keypad (or virtual keypad in cooperation with capacitive touch display screen 205) for inputting text for communications. In accordance with some embodiments, the input 206 may include a suitable interface, for example, a hardware or graphical user interface PTT button that functions to activate a transmit function in a half-duplex communication mode, transitioning the computing device 110 (when activated) from a listen-only mode to a transmit-only mode for half-duplex communication. The display screen 205 may further function to display communications received via communications unit 202 from other devices.

A microphone 220 may be provided at the computing device to capture speech input from a user that is further vocoded by processing unit 203 and transmitted as voice, text, or multimedia data by communications unit 202 to other communication devices in the system 100. A communications speaker 222 may be provided to reproduce audio that is decoded from voice data transmissions received from other communication devices via the communications unit 202. The computing device 110 may also include an imaging device 221 that captures video (still or moving images) of an area in a field of view of the computing device 110 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the computing device 110, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications interface 202.

Static memory 216 may store operating code 225 for the electronic processor 213 that, when executed, performs one or more of the blocks set forth in the figures, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 is also configured to store client-side applications including the first application 112 and the second application 114 described with reference to FIG. 1, among other program data, filters, rules, one or more program modules, and/or other executable instructions.

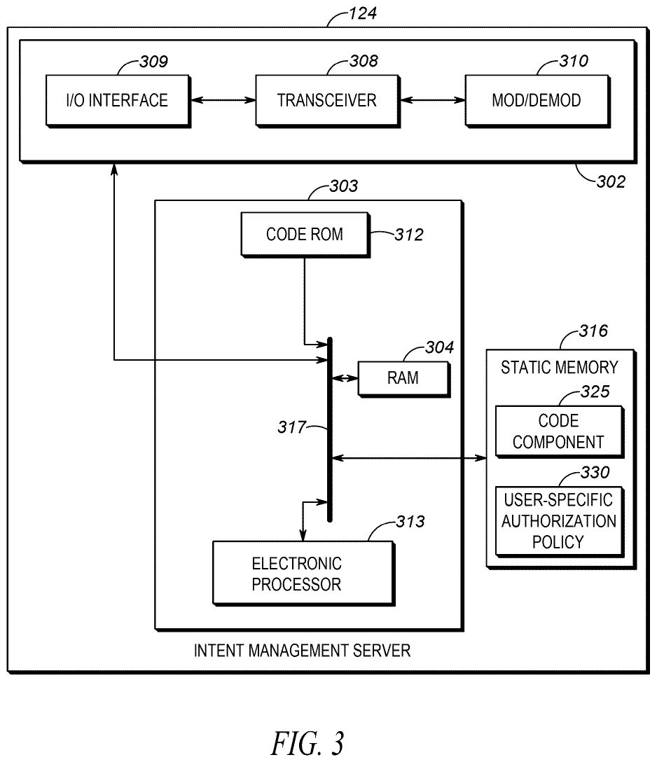

Now referring to FIG. 3, a schematic diagram illustrates an intent management server 124 shown in FIG. 1 in accordance with some embodiments. The intent management server 124 may be a standalone device or alternatively implemented as a distributed computing device across two or more of the foregoing (or multiple of the same type of one of the foregoing) and linked via a wired and/or wireless communication link(s). The intent management server 124 may also be implemented in a cloud computing platform. Depending on the type of the server, the intent management server 124 may include fewer or additional components in configurations different from that illustrated in FIG. 3.

As shown in FIG. 3, the intent management server 124 includes a communications unit or communications interface 302 coupled to a common data and address bus 317 of the processing unit 303. The communications unit 302 may include one or more wired or wireless input/output (I/O) interfaces 309 that are configurable to communicate with other devices in or communicably coupled to the system 100. The communications unit 302 may include one or more wireless transceivers 308, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, an LTE or 5G transceiver, and/or other similar type of wireless transceiver configurable to communicate via a wireless radio network. The communications unit 302 may additionally include one or more wireline transceivers 308, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceiver 308 is also coupled to a combined modulator/demodulator 310 that is coupled to the processing unit 303.

The processing unit 303 may include a code Read Only Memory (ROM) 312 for storing data for initializing system components, and encoding and/or decoding voice, data, control, or other signals that may be transmitted or received between the intent management server 124 and other devices in the system 100. The processing unit 303 includes an electronic processor or microprocessor 313 coupled, by the common data and address bus 317, to a Random Access Memory (RAM) 304, and a static memory 316.

Static memory 316 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few. Static memory 316 stores operating code 325 for the electronic processor 313 that, when executed, performs one or more of the functions set forth in the figures and accompanying text. Static memory 216 may store (or intent management server 124 has access to, via the communications unit 302) one or more user-specific authorization policies 330. The user-specific authorization policies 330 may be provisioned at the intent management server 124 based on input received by a security administrator of the computing device 110. The user-specific authorization policy 330 may be provisioned using any suitable data formats (e.g., JavaScript Object Notation or JSON, Extensible Markup Language or XML, etc.,), enabling the intent management server 124 to parse, process, and enforce the user-specific authorization policy. In accordance with some embodiments, the user-specific authorization policy comprises of data components including (i) a user component identifying a specific entity (e.g., user or user role) for which the policy applies, (ii) resource component identifying the specific application(s) (e.g., first application 112), and (iii) intent component identifying a list of intents that are allowed (or disallowed) for either invocation or acceptance on behalf of the specific entity. The user-specific authorization policy may also optionally include a time component indicating an expiration time after which the user-specific authorization policy is no longer valid and a device component identifying a particular computing device or a set of computing devices to which the user-specific authorization policy applies. The user-specific authorization policy 330 may be different for different users using the same application. For example, the intent management server may be provisioned with a first user-specific authorization policy for a first user and a second user-specific authorization policy for a second user. In this example, the first user-specific authorization policy associated with the first user of a first application 112 may define a list of allowed intents that the first application 112 is authorized, on behalf of the first user, to invoke with or accept from one or more other applications such as the second application 114 running on the computing device 110. A user-specific authorization policy associated with the first user of the first application 112 may also define a list of disallowed intents (in addition to or alternative to defining the list of allowed intent) that the first application 112 is not authorized, on behalf of the first user, to invoke with or accept from one or more other applications such as the second application 114 running on the computing device 110. The second user-specific authorization policy may be similarly provisioned for the second user at the intent management server 124 to define a list of allowed and/or disallowed intents that the first application 112 is authorized and/or not authorized, on behalf of the second user, to invoke with or accept from one or more other applications such as the second application 114 running on the computing device 110.

In accordance with some embodiments, the intent management server 134 associated with the second application domain 130 is similarly implemented using the electronic components shown in FIG. 3. For example, the intent management server 134 may include a communications interface including one or more wireless transceivers, a processing unit including an electronic processor and a memory including operating code, program, and instructions that, when executed by the electronic processor, enable the intent management server 134 to perform a set of similar functions and operations described herein with reference to the figures and the accompanying text. Furthermore, the intent management server 134 may be similarly provisioned with one or more user-specific authorization policies to define a list of allowed and/or disallowed intents that the second application 114 is authorized and/or not authorized, on behalf of a particular user using the second application 114, to invoke with or accept from one or more other applications such as the first application 112 running on the computing device 110.

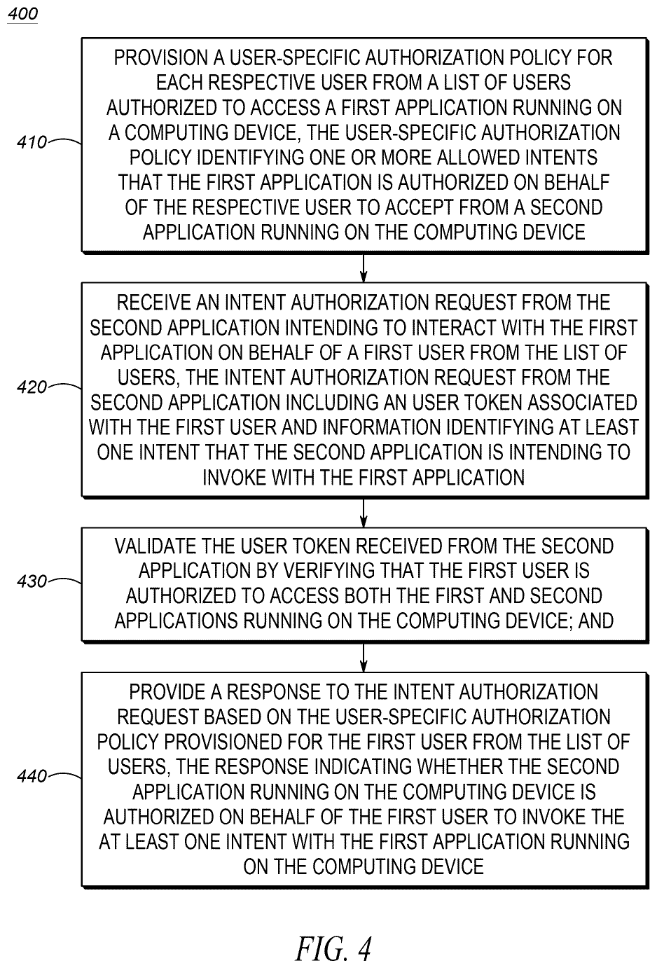

Turning now to FIG. 4, a flowchart diagram illustrates a process 400 for authorizing an interaction between applications (e.g., first and second applications 112, 114) running on a computing device 110. While a particular order of processing steps, message receptions, and/or message transmissions is indicated in FIG. 4 as an example, timing and ordering of such steps, receptions, and transmissions may vary where appropriate without negating the purpose and advantages of the examples set forth in detail throughout the remainder of this disclosure. The intent management server 124 shown in FIG. 1 and/or FIG. 3, and embodied as a singular computing device or distributed computing device may execute process 400 via an electronic processor 313.

The intent management server 124 may execute the process 400 at power-on, at some predetermined periodic time period thereafter, in response to a trigger raised locally at the computing device 110 via an internal process or via an input interface or in response to a trigger from an external device to which the intent management server 124 is communicably coupled, among other possibilities.

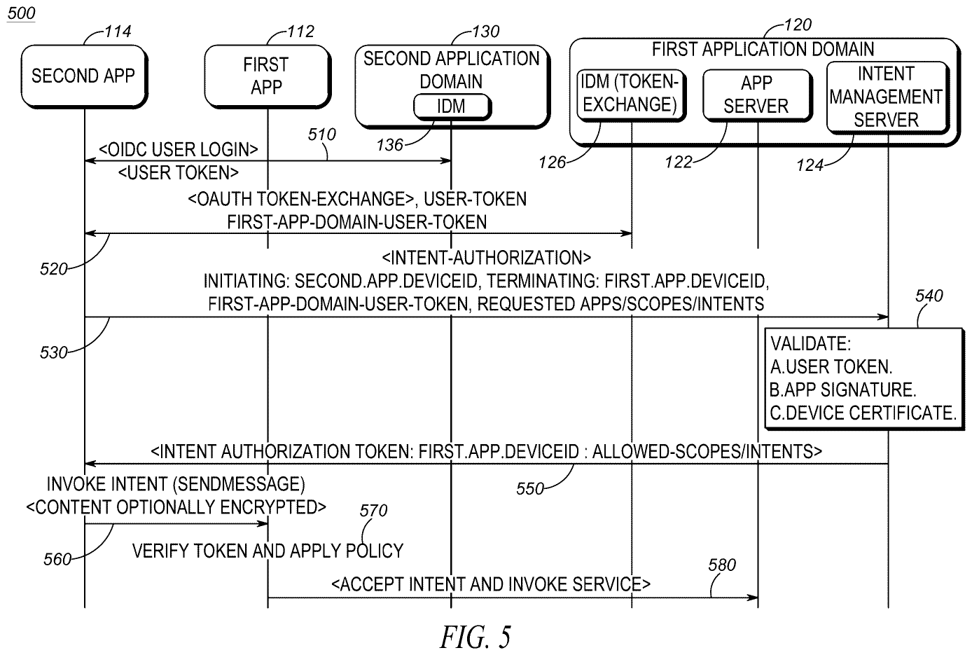

The process 400 of FIG. 4 need not be performed in the exact sequence as shown and likewise various blocks may be performed in different order or alternatively in parallel rather than in sequence. The process 400 may be implemented on variations of the system 100 of FIG. 1 as well. The process 400 is also further described in detail in the example message flow diagram 500 illustrated in FIG. 5.

At block 410, the intent management server 124 is provisioned with a user-specific authorization policy (e.g., user-specific authorization policy 330) for each respective user from a list of users authorized to access a first application 112 running on the computing device 110. As described previously, the user-specific authorization policy may be provisioned at the intent management server 124 based on input received from a security administrator of the computing device 110 or a user for whom the policy applies. The user-specific authorization policy identifies one or more allowed intents that the first application 112 is authorized on behalf of the respective user to accept from a second application 114 running on the same computing device 110. In one embodiment, the user-specific authorization policy may alternatively identify one or more disallowed intents that the first application 112 is not authorized on behalf of the respective user to accept from the second application 114 running on the same computing device 110.

At block 420, the intent management server 124 serving the first application 112 receives an intent authorization request from the second application 114 which intends to interact with the first application 112 on behalf of a first user from the list of users. The first user refers to any user who is authorized to access the second application 114, for example, after successfully logging into the second application 114. The intent authorization request from the second application 114 includes a user token associated with the first user and information identifying at least one intent that the second application 114 is intending to invoke with the first application 112. The term “user token” refers to any digital credential (e.g., JSON token) issued by an identity management server (e.g., identity management server 136 serving the second application 114) after a user (e.g., the first user) successfully authenticates and authorizes an application (e.g., the second application 114) to access specific resources on their behalf. The user token serves as a proof of the user's identity and their granted permissions allowing an application to access protected resources without requiring the user to repeatedly log in. In one example, the user token contains user information (e.g., user ID or role), expiration time (e.g., defining when the token expires), and signature verifying that the token was issued by a trusted identity management server (e.g., identity management server 136).

At block 430, the intent management server 124 validates the user token received from the second application 114 by verifying that the first user is authorized to access both the first application 112 and second application 114 running on the same computing device 110. In one embodiment, the intent management server 124 compares the user token received from the second application 114 to a user token received from an identity management server 126 serving the first application 112. The identity management server 126 serving the first application 112 may similarly issue a user token after a user (e.g., the first user who has also been issued a user token after verification by the identity management server 136 serving the second application 114) authenticates and authorizes an application (e.g., the first application 112) to access specific resources on their behalf. When the user token received from the second application 114 matches (or is associated with the same identity) with the user token issued by the identity management server 126 serving the first application 112, the intent management server 124 determines that a same user (also referred herein as “the first user”) is authorized to access both the first and second applications 112, 114 running on the same computing device 110. The user token included in the intent authorization request received from the second application 114 is successfully validated when the intent management server 124 determines that the first user is authorized to access both the first and second applications 112, 114 running on the same computing device 110.

At block 440, the intent management server 124 provides a response to the intent authorization request based on the user-specific authorization policy provisioned for the first user from the list of users. The response indicates whether the second application 114 running on the computing device 110 is authorized on behalf of the first user to invoke the at least one intent (i.e., the particular intent identified in the intent authorization request received at block 420) with the first application 112 running on the same computing device 110. In accordance with some embodiments, when the intent management server 124 successfully validates the user token received from the second application 114, the intent management server 124 retrieves a user-specific authorization policy provisioned particularly for the specific user (i.e., the first user) corresponding to whom the user token is validated. The user-specific authorization policy retrieved for the first user may identify may one or more allowed intents that the second application 114 is authorized on behalf of the first user to invoke with the first application 112. The intent management server 124 then determines whether the at least one intent as requested by the second application 114 in the intent authorization request is included in the identified one of one or more allowed intents specified in the user-specific authorization policy. If the at least one intent requested by the second application 114 is included in the one or more allowed intents specified by the user-specific authorization policy, then the intent management server 124 generates a response to the intent authorization request. The response includes an intent authorization token indicating that the second application 114 running on the computing device 110 is authorized on behalf of the first user to invoke the at least one intent with the first application 112 running on the same computing device 110. The intent authorization token may include one or more of: user information (e.g., user ID of the first user authorized to use the first and second applications 112, 114), application identifier of the first application 112 or device identifier of the device 110 running the first application 112, information indicating that the at least one intent is allowed for invocation with the first application 112, expiration time defining when the intent authorization token will expire, and a signature verifying that the token was issued by a trusted intent management server 124. The second application 114 may then use the intent authorization token to invoke the at least one intent with the first application 112.

On the other hand, if the at least one intent requested by the second application 114 is not included in the one or more allowed intents specified in the user-specific authorization policy, then the intent management server 124 generates a response to the intent authorization request to indicate to the second application 114 that the second application 114 running on the computing device 110 is not authorized on behalf of the first user to invoke at least one intent with the first application 112 running on the same computing device 110. In this case, the second application 114 cannot invoke the at least one intent with the first application 112 without an intent authorization token.

FIG. 5 is a message flow diagram 500 illustrating the process 400 described above with reference to FIG. 4 in accordance with some embodiments. In the example shown in FIG. 5, assume the second application 114 is a fall detection application (also referred herein as a service provider application) installed and running on the computing device 110 and the first application 112 is a call application (also referred herein as a MCPTT application) installed and running on the computing device 110. Further assume the second application 114 is programmed to detect a fall condition (e.g., based on data obtained from sensors such as accelerometers and gyroscopes provided at the computing device 110) corresponding to a first user who is authorized to use the second application 114 and to further invoke an intent with the first application 112 to request the first application 112 to make an emergency call reporting the detected fall condition to a predefined emergency contact number. In accordance with the embodiments described herein, the second application 114 is further programmed to request an intent management server 124 serving the first application 112 for an intent authorization token before invoking an intent (i.e., to request the first application 112 to make an emergency call reporting the detected fall condition) with the first application 112. In accordance with some embodiments, the first application 112 is programmed to accept an intent invoked by another application such as the second application 114 when an intent authorization token received from the second application 114 is successfully validated.

The message flow diagram 500 illustrates messages exchanged between the first and second applications 112, 114, the first application domain 120 including the application server 122, intent management server 124, and identity management server 126, and the second application domain 130 including the identity management server 136 in facilitating the second application's 114 request to interact with the first application 112.

Before the second application 114 can interact with another application such as the first application 112 on behalf of a user, a user (e.g., the “first user” described in the process 400 illustrated in FIG. 4) needs to successfully log into the second application 114. As shown in FIG. 5, the second application 114 and the identity management server 136 serving the second application 114 exchanges messages 510 to validate user credentials of a user attempting to access or log into the second application 114. In one embodiment, OpenID Connect (OIDC) authentication protocol may be used to enable the user to login and access applications by verifying their identity through the identity management server 136. After the user successfully authenticates with the identity management server 136 and authorizes the second application 114 to execute on behalf of the user, the second application 114 receives a user token associated with the user. The second application 114 then exchanges messages 520 with the identity management server 126 serving the first application 112 to send the user token obtained by the second application 114 from the identity management server 136 and to further obtain a user token (e.g., first-app-domain-user-token) of a user authorized to access the first application 112. If the same user is logged in both the first and second applications 112 running on the same computing device 110, then the user token obtained from the identity management server 126 serving the first application 112 matches (or associates with the identity of the same user) with the user token obtained from the identity management server 136 serving the second application 114.

The second application 114 then sends an intent authorization request message 530 to the identity management server 126 serving the first application 112. In one embodiment, the intent authorization request message 530 may include the following information: (i) application identifier of an initiating application (i.e., the second application 114) i.e., an application which is requesting to invoke an intent, (ii) application identifier of a terminating application (i.e., the first application 112) i.e., an application which will be requested to accept the intent, (iii) device identifier of a device (i.e., the computing device 110) running the initiating application, (iv) a user token (i.e., first-app-domain-user-token) obtained from an intent management server (e.g., intent management server 124) serving the terminating application, and (iv) intent (e.g., defining the scope and nature of actions) to be invoked.

The intent management server 124 receives the intent authorization request message 530 and processes the information included in the intent authorization request message in accordance with the user-specific authorization policy provisioned for a particular user authorized to use the first application 112. More particularly, the intent management server 124 validates 540 the user token received in the intent authorization request message 530 by checking whether the user token (i.e., first-app-domain-user-token) matches with (or associates with the identity of the same user) a user token of a user who is authorized to use the first application 112. After successfully validating the user token, the intent management server 124 parses the user-specific authorization policy provisioned for the particular user to determine whether the intent to be invoked by the second application 114 is included in the list of allowed intents that the second application 114 is authorized on behalf of the user (i.e., user associated with the user token) to invoke with the first application 112. If the intent to be invoked by the second application 114 is included in the list of allowed intents, then the intent management server issues an intent authorization token indicating that the second application 114 is authorized on behalf of the user to invoke the intent with the first application 112. In one embodiment, prior to issuing the intent authorization token, the intent management server 124 may additionally validate 540 the authenticity of the originating application or the second application 114, for example, by verifying that an application signature associated with the second application 114 is cryptographically signed by the second application 114 intending to interact with the first application 112. The intent management server 124 may also further validate 540, prior to issuing the intent authorization token, the computing device 110, for example, by verifying a device identifier or certificate of the computing device 110 running the originating application in accordance with the user-specific authorization policy defined for the user using the first application 112. The intent management server 124 may verify the device identifier by determining that the device identifier retrieved from the intent authorization request is associated with one or more particular computing devices identified as being valid in the user-specific authorization policy. In these embodiments, the intent management server 124 may also determine that an expiration time (e.g., a time defined by the user-specification policy after which the policy provisioned for a particular user is no longer valid) has not expired before issuing the intent authorization token.

After the validation process 540, the intent management server 124 generates a response message 550 including an intent authorization token. The intent authorization token is also cryptographically signed by the intent management server 124 to prove the authenticity of the intent authorization token. The intent authorization token includes, among other things, information identifying the scope and nature of the intent that the second application 114 is permitted to invoke with the first application 112. The scope and nature of the intent as permitted in the intent authorization token may remain the same as requested by the second application 114 via the intent authorization request message 530. In one embodiment, the scope and nature of the intent may be more limited than the one requested by the second application 114 when the user-specific authorization policy defines a restriction corresponding to an intent allowed to be invoked on behalf of a user. As an example, the policy may define that a first application 112 can accept an intent to make a call to a predefined emergency number, but cannot accept an intent requesting the first application 112 to make a call to any contact other than the predefined emergency number.

In one embodiment, after receiving the response message 550 containing the intent authorization token, the second application 114 invokes an intent by sending an intent acceptance request message 560 to the first application 112 to request the first application 112 to accept the intent and further execute one or more actions or services (e.g., making a call reporting the fall detection event corresponding to the user to a predefined emergency number) included in the intent. The intent acceptance request message 560 includes the intent authorization token received from the intent management server 124 serving the first application 112 along with a message object representing the intent to be executed/accepted by the second application 114. The content of the intent acceptance request message 560 is optionally encrypted, for example, using cryptographic parameters associated with a user authorized to use the second application 114. In this embodiment, the first application 112 is able to decrypt the intent acceptance request 560 using cryptographic parameters of a user authorized to use the first application 112 when the first and second applications 112, 114 are logged in by the same user.

After receiving the intent acceptance request message 560 from the second application 114, the first application 112 validates the intent authorization token included in the intent acceptance request 560 by verifying 570 that the authorization token is cryptographically signed by the intent management server 124 serving the first application 112. After validating the intent authorization token, the first application 112 accepts 580 the intent and executes one or more actions or services defined by the intent requested in the intent acceptance request in accordance with the scope and nature of the allowed intents as determined by the intent management server 124 in accordance with the user-specific authorization policy. As an example, the first application 112 may execute/invoke an action (e.g., by communicating with the application server 122 supporting the first application 112) defined by the intent in order to provide a service such as to call a predefined emergency number and report a fall-detection event corresponding to a user. Although FIG. 5 shows that the first application 112 is executing the action defined by the requested intent by invoking a call with an application server 122, in some cases, an action specified in the requested intent may be executed by the first application 112 locally (i.e., without calling the application server 122), for example, by retrieving information stored at a local memory (e.g., static memory 216 of the computing device 110) that is accessible to the first application 112.

In one embodiment, after receiving the response message 550 containing the intent authorization token, the second application 114 binds the intent authorization token with the first application 112 before invoking an intent (e.g., via an intent acceptance request message 560) with the first application 112. Binding the intent authorization token allows the second application 114 to interact with the first application 112 any number of times (unless restricted by the token) with the first application 112 before the intent authorization token expires. In one embodiment, the second application 114 binds the intent authorization token with the first application 112 by sending a binding request including the intent authorization token to the first application 112. The first application 112 in response validates the intent authorization token by verifying 570 that the intent authorization token is cryptographically signed by the intent management server 124. After validation, the first application 112 then generates and sends a response to the second application 114 indicating that the binding of the intent authorization token is successful at the first application 112. After the binding is successful, the second application 114 is able to invoke any intent (authorized by the intent authorization token) repeatedly (before the token expires) with the first application 112. Further, in this case, the second application 114 is not required to include the intent authorization token each time an intent acceptance message is sent to the first application 112.

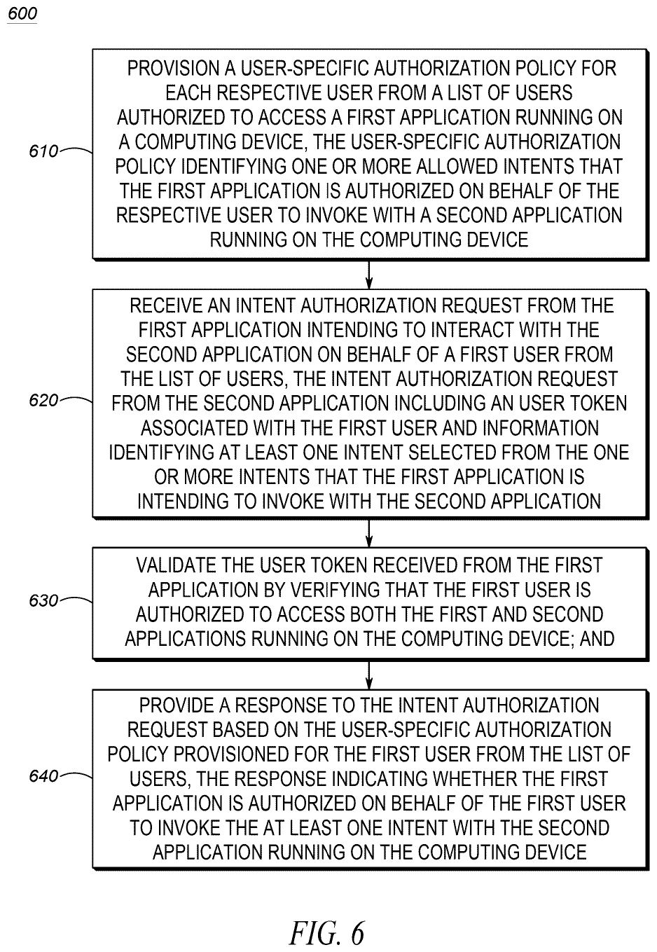

Turning now to FIG. 6, a flowchart diagram illustrates another process 600 for authorizing an interaction between applications (e.g., first and second applications 112, 114) running on a computing device 110. While a particular order of processing steps, message receptions, and/or message transmissions is indicated in FIG. 6 as an example, timing and ordering of such steps, receptions, and transmissions may vary where appropriate without negating the purpose and advantages of the examples set forth in detail throughout the remainder of this disclosure. The intent management server 124 shown in FIG. 1 and/or FIG. 3, and embodied as a singular computing device or distributed computing device may execute process 600 via an electronic processor 313.

The intent management server 124 may execute the process 600 at power-on, at some predetermined periodic time period thereafter, in response to a trigger raised locally at the computing device 110 via an internal process or via an input interface or in response to a trigger from an external device to which the intent management server 124 is communicably coupled, among other possibilities.

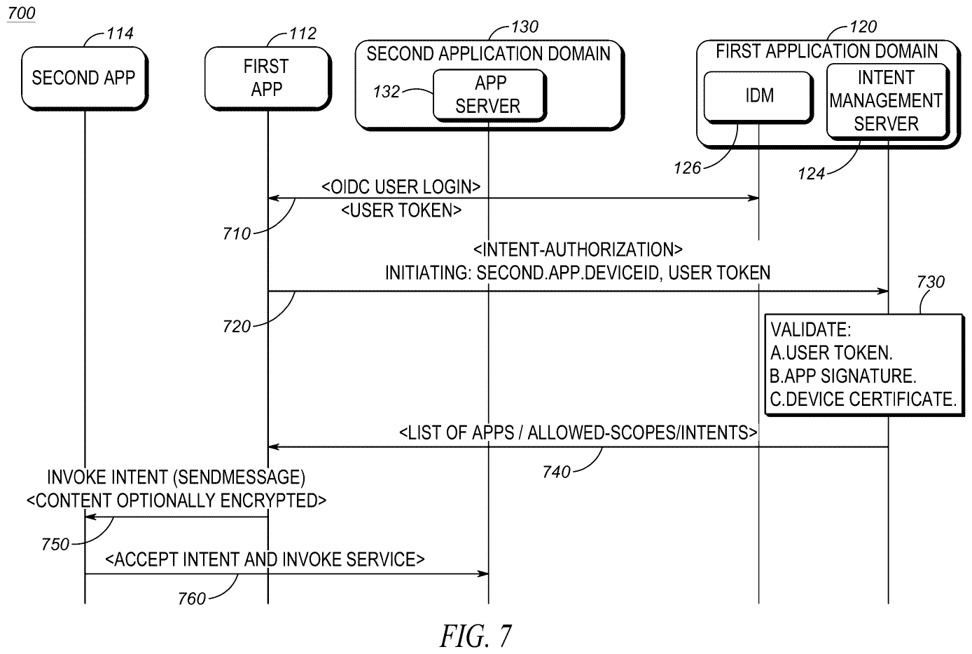

The process 600 of FIG. 6 need not be performed in the exact sequence as shown and likewise various blocks may be performed in different order or alternatively in parallel rather than in sequence. The process 600 may be implemented on variations of the system 100 of FIG. 1 as well. The process 600 is also further described in detail in the example message flow diagram 700 illustrated in FIG. 7.

At block 610, the intent management server 124 is provisioned with a user-specific authorization policy (e.g., user-specific authorization policy 330) for each respective user from a list of users authorized to access a first application 112 running on a computing device 110. As described previously, the user-specific authorization policy may be provisioned at the intent management server 124 based on input received from a security administrator of the computing device 110 or a user for whom the policy applies. The user-specific authorization policy identifies one or more allowed intents that the first application 112 is authorized on behalf of the respective user to invoke with a second application 114 running on the same computing device 110. In one embodiment, the user-specific authorization policy may alternatively identify one or more disallowed intents that the first application 112 is not authorized on behalf of the respective user to invoke with the second application 114 running on the same computing device 110.

At block 620, the intent management server 124 serving the first application 112 receives an intent authorization request from the first application 112 which intends to interact with the second application 114 on behalf of a first user from the list of users. The first user refers to any user who is authorized to access the first application 112, for example, after successfully logging into the first application 112. The intent authorization request from the first application 112 includes a user token associated with the first user and information identifying at least one intent that the first application 112 is intending to invoke with the second application 114. The term “user token” refers to any digital credential (e.g., JSON token) issued by an identity management server (e.g., identity management server 126 serving the first application 112) after a user (e.g., the first user) successfully authenticates and authorizes an application (e.g., the first application 112) to access specific resources on their behalf. The user token serves as a proof of the user's identity and their granted permissions allowing an application to access protected resources without requiring the user to repeatedly log in. In one example, the user token contains user information (e.g., user ID or role), expiration time (e.g., defining when the token expires), and signature verifying that the token was issued by a trusted identity management server (e.g., identity management server 126).

At block 630, the intent management server 124 validates the user token received from the first application 112 by verifying that the first user is authorized to access both the first application 112 and second application 114 running on the same computing device 110. In accordance with some embodiments, the intent management server 124 compares the user token received from the first application 112 to a user token received from an identity management server 136 serving the second application 114. The identity management server 136 serving the second application 114 may similarly issue a user token after a user (e.g., the first user who has also been issued a user token after verification by the identity management server 126 serving the first application 112) authenticates and authorizes an application (e.g., the second application 114) to access specific resources on their behalf. When the user token received from the first application 112 matches (or is associated with the same identity) with the user token issued by the identity management server 136 serving the second application 114, the intent management server 124 determines that a same user (also referred herein as “the first user”) is authorized to access both the first and second applications 112, 114 running on the same computing device 110. The user token received from the first application 112 is successfully validated when the intent management server 124 determines that the first user is authorized to access both the first and second applications 112, 114 running on the same computing device 110.

At block 640, the intent management server 124 provides a response to the intent authorization request based on the user-specific authorization policy provisioned for the first user from the list of users. The response indicates whether the first application 112 running on the computing device 110 is authorized on behalf of the first user to invoke the at least one intent (as identified in the intent authorization request received at block 620) with the second application 114 running on the same computing device 110. In accordance with some embodiments, when the intent management server 124 successfully validates the user token received from the first application 112, the intent management server 124 retrieves a user-specific authorization policy provisioned particularly for the user (i.e., the first user) against whom the user token is validated. The user-specific authorization policy retrieved for the first user may identify may one or more allowed intents that the first application 112 is authorized on behalf of the first user to invoke with the second application 114. The intent management server 124 then determines whether the at least one intent as requested by the first application 112 in the intent authorization request is included in the identified one of one or more allowed intents included in the user-specific authorization policy. If the at least one intent requested by the first application 112 is included in the one or more allowed intents specified by the user-specific authorization policy, then the intent management server 124 generates a response to the intent authorization request indicating that the first application 112 running on the computing device 110 is authorized on behalf of the first user to invoke the at least one intent with the second application 114 running on the same computing device 100. On the other hand, if the at least one intent requested by the second application 114 is not included in the one or more allowed intents included in the user-specific authorization policy, then the intent management server 124 generates a response to the intent authorization request to indicate to the second application 114 that the second application 114 running on the computing device 110 is not authorized on behalf of the first user to invoke at least one intent with the first application 112 running on the same computing device 110. In accordance with embodiments, the first application 112 is permitted to invoke at least one intent with the second application 114 only in response to receiving information from the intent management server 124 indicating that the at least one intent is included in the list of allowed intents specified in the user-specific authorization policy.

FIG. 7 is a message flow diagram 700 illustrating the process 600 described above with reference to FIG. 6 in accordance with some embodiments. In the example shown in FIG. 7, assume the first application 112 is a messaging application installed and running on the computing device 110 and the second application 114 is a map application installed and running on the computing device 110. Further assume the first application 112 is intending to invoke an intent with the second application 114 to request the second application 114 to retrieve and share the user's current location with the first application 112. In accordance with the embodiments described herein, the first application 112 is further programmed to communicate with an intent management server 124 serving the first application 112 before requesting invoking an intent with another application such as the second application 114. More particularly, the first application 112 verifies that the intent to be invoked (i.e., to request the second application 114 to retrieve and share user's current location) with the second application 114 is included in a list of allowed intents (as specified in the user-specific authorization policy provisioned for the user) that the first application 112 is authorized on behalf of a user using the first application 112 to invoke with the second application 114.

The message flow diagram 700 illustrates messages exchanged between the first and second applications 112, 114, the first application domain 120 including the intent management server 124 and identity management server 126, and the second application domain 130 including the application server 132 in facilitating the first application's 112 request to interact with the second application 114.

Before the first application 112 can interact with another application such as the second application 114 on behalf of a user, a user (e.g., the “first user” described in the process 600 illustrated in FIG. 6) needs to successfully log into the first application 112. As shown in FIG. 7, the first application 112 and the identity management server 126 serving the first application 112 exchanges messages 710 to validate user credentials of a user attempting to access or log into the first application 112. In one embodiment, OpenID Connect (OIDC) authentication protocol may be used to enable the user to login and access applications by verifying their identity through the identity management server 126. After the user successfully authenticates with the identity management server 126 and authorizes the first application 112 to execute on behalf of the user, the first application 112 receives a user token associated with the user.

The first application 112 then sends an intent authorization request message 720 to the intent management server 124 serving the first application 112. In one embodiment, the intent authorization request message 720 may include the following information: (i) an application identifier of an initiating application or an application (e.g., the first application 112) which is requesting to invoke an intent, (iii) a device identifier of a device (i.e., the computing device 110) running the initiating application, (iv) a user token obtained from an identity management server (e.g., identity management server 126) serving the initiating application, and (iv) intent (e.g., defining the scope and nature of actions) to be invoked. The intent authorization request message may also additionally include an application identifier of a terminating application or an application (e.g., the second application 114) with which the initiating application is intending to invoke an intent.

The intent management server 124 receives the intent authorization request message 530 and processes the information included in the intent authorization request message in accordance with the user-specific authorization policy provisioned for a particular user authorized to use the first application 112. More particularly, the intent management server 124 validates 730 the user token received in the intent authorization request message 530 by checking whether the user token matches with (or associates with the identity of a same user) a user token of a user who is authorized to use the second application 114. After successfully validating the user token, the intent management server 124 parses the user-specific authorization policy provisioned for the particular user to determine whether the intent to be invoked by the first application 112 is included in the list of allowed intents that the first application 112 is authorized on behalf of the user (i.e., user associated with the user token) to invoke with another application such as the second application 114 indicated in the intent authorization request message 720. The intent management server 124 then sends a response message 740 indicating whether or not the first application 112 is allowed on behalf of the user using the first application 112 to invoke the intent (i.e., intent indicated in the intent authorization request message 720) with the second application 114. Additionally or alternatively, the response message 740 may include a list of intents (and its allowed scope and nature) that the first application 112 is allowed on behalf of the user using the first application 112 to invoke with another application such as the second application 114. In one embodiment, prior to sending the response message 740, the intent management server 124 may additionally validate 540 the authenticity of the first application 112, for example, by verifying that an application signature associated with the second application 114 is cryptographically signed by the first application 112 intending to interact with the second application 114. The intent management server 124 may also further validate 540, prior to sending the response message 740, the computing device 110, for example, by verifying a device identifier or certificate of the computing device 110 running the second application 114 in accordance with the user-specific authorization policy defined for the user using the first application 112. The intent management server 124 may verify the device identifier by determining that the device identifier retrieved from the intent authorization request is associated with one or more particular computing devices identified as being valid in the user-specific authorization policy. In these embodiments, the intent management server 124 may also determine that an expiration time (e.g., a time defined by the user-specification policy after which the policy provisioned for a particular user is no longer valid) has not expired before sending the response message 740.

The first application 112 receives and processes the response message 740 to determine whether the intent the first application 112 is intending to invoke with the second application 114 is included in the list of allowed intents specified in the response message. If the intent is included in the list of allowed intents, then the first application 112 invokes the intent by sending an intent acceptance request message 750 to the second application 114 to request the second application 114 to accept the intent and further execute one or more actions (e.g., retrieving and sharing user's current location) included in the intent. In one embodiment, the content of the intent acceptance request message 750 is optionally encrypted, for example, using cryptographic parameters associated with a user authorized to use the first application 112. In this embodiment, the first application 112 is able to decrypt the intent acceptance request message 750 using cryptographic parameters of a user authorized to use the second application 114 when the first and second applications 112, 114 are logged in by the same user.

After receiving the intent acceptance request message 750 from the first application 112, the second application 114 accepts the intent and executes one or more actions defined by the intent requested in the intent acceptance request message 750. As an example, the second application 114 may execute/invoke 760 an action or service defined by the intent by communicating with an application server 132 (e.g., GPS server) and obtaining data (e.g., GPS data) corresponding to the user's current location and further send a message to the first application 112 including the data retrieved corresponding to the user's current location. Although FIG. 7 shows that the second application 114 is executing the action defined by the requested intent by communicating with an application server 132, in some cases, the intent may be executed by the second application 114 locally (i.e., without calling the application server 132), for example, by retrieving information stored at a local memory (e.g., static memory 216 of the computing device 110) that is accessible to the second application 114.

In one embodiment, prior to accepting the intent invoked by the first application 112, the second application 114 may perform a process that is similar to the process 400 described in FIG. 4 to verify (e.g., by communicating with the intent management server 134 serving the second application 114) whether the intent requested by the first application 112 is included in a list of allowed intents (e.g., as specified in user-specific authorization policy provisioned on behalf of a user using the second application 114) that the second application 114 is authorized to accept from the first application 112. In this embodiment, the second application 114 accepts the intent requested by the first application 112 only when the intent management server 134 verifies that the intent is included in a list of intents that the second application 114 is authorized to accept on behalf of a user using the second application 114.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued. Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . .a”, “has . . .a”, “includes . . .a”, “contains . . .a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for enforcing a user-specific authorization policy for authorizing an interaction between applications running on a same computing device, the method comprising:
provisioning, at an intent management server, a user-specific authorization policy for each respective user from a list of users authorized to access a first application running on a computing device, the user-specific authorization policy identifying one or more allowed intents that the first application is authorized on behalf of the respective user to accept from a second application running on the computing device;
receiving, at the intent management server, an intent authorization request from the second application intending to interact with the first application on behalf of a first user from the list of users, the intent authorization request from the second application including an user token associated with the first user and information identifying at least one intent that the second application is intending to invoke with the first application;
validating, at the intent management server, the user token received from the second application by verifying that the first user is authorized to access both the first and second applications running on the computing device; and
providing, at the intent management server, a response to the intent authorization request based on the user-specific authorization policy provisioned for the first user from the list of users, the response indicating whether the second application running on the computing device is authorized on behalf of the first user to invoke the at least one intent with the first application running on the computing device.

2. The method of claim 1, wherein providing the response comprises:
determining, after validating the user token, from the user-specific authorization policy provisioned for the first user, whether the at least one intent is included in the one or more allowed intents that the first application is authorized to accept from the second application running on the computing device; and
when it is determined that the at least one intent is not included in the one or more allowed intents that the first application is authorized to accept from the second application running on the computing device, including a message in the response to indicate that the second application running on the computing device is not authorized on behalf of the first user to invoke the at least one intent with the first application running on the computing device.

3. The method of claim 1, wherein providing the response comprises:
determining, after validating the user token, from the user-specific authorization policy provisioned for the first user, whether the at least one intent is included in the one or more allowed intents that the first application is authorized to accept from the second application running on the computing device; and
when it is determined that the at least one intent is included in the one or more allowed intents that the first application is authorized to accept from the second application running on the computing device, issuing, at the intent management server, an intent authorization token with the response to indicate that the second application running on the computing device is authorized on behalf of the first user to invoke the at least one intent with the first application running on the computing device.

4. The method of claim 3, wherein the user-specific authorization policy further defines an expiration time after which the user-specific authorization policy provisioned for each respective user is no longer valid, the method further comprising:
determining, at the intent management server, that the expiration time has not expired before issuing the intent authorization token.

5. The method of claim 3, wherein the user-specific authorization policy further identifies one or more particular computing devices for which the user-specific authorization policy is valid, the method further comprising:
retrieving, at the intent management server, from the intent authorization request, a device identifier associated with the computing device running the first and the second applications; and
determining, at the intent management server, that the device identifier is associated with the one or more particular computing devices identified in the user-specific authorization policy before issuing the intent authorization token.

6. The method of claim 3, further comprising:
retrieving, at the intent management server, an application signature from the intent authorization request; and
prior to issuing the intent authorization token, validating, at the intent management server, the application signature by verifying that the application signature is cryptographically signed by the second application intending to interact with the first application.

7. The method of claim 3, further comprising:
binding the intent authorization token at the first application to enable the interaction between the first and second applications.

8. The method of claim 3, further comprising:
receiving, by the first application, an intent acceptance request from the second application, the intent acceptance request indicating that the second application is intending to invoke the at least one intent with the first application on behalf of the first user, the intent acceptance request further including the intent authorization token received by the second application from the intent management server;
validating, by the first application, the intent authorization token by verifying that the intent authorization token is cryptographically signed by the intent management server;
retrieving, after validating the intent authorization token, the user-specific authorization policy provisioned for the first user; and
accepting, by the first application, the at least one intent invoked by the second application in accordance with the retrieved user-specific authorization policy.

9. The method of claim 8, further comprising:
executing, by the first application, an action defined by the at least one intent in response to accepting the at least one intent.

10. A method for enforcing a user-specific authorization policy for authorizing an interaction between applications running on a same computing device, the method comprising:
provisioning, at an intent management server, a user-specific authorization policy for each respective user from a list of users authorized to access a first application running on a computing device, the user-specific authorization policy identifying one or more allowed intents that the first application is authorized on behalf of the respective user to invoke with a second application running on the computing device;
receiving, at the intent management server, an intent authorization request from the first application intending to interact with the second application on behalf of a first user from the list of users, the intent authorization request from the first application including an user token associated with the first user and information identifying at least one intent selected from the one or more intents that the first application is intending to invoke with the second application;
validating, at the intent management server, the user token received from the first application by verifying that the first user is authorized to access both the first and second applications running on the computing device; and
providing, at the intent management server, a response to the intent authorization request based on the user-specific authorization policy provisioned for the first user from the list of users, the response indicating whether the first application is authorized on behalf of the first user to invoke the at least one intent with the second application running on the computing device.

11. The method of claim 10, wherein providing the response comprises:
determining, after validating the user token, from the user-specific authorization policy provisioned for the first user, whether the at least one intent is included in the one or more allowed intents that the first application is authorized to invoke with the second application running on the computing device; and
when it is determined that the at least one intent is not included in the one or more allowed intents that the first application is authorized to invoke with the second application running on the computing device, including a message in the response to indicate that the first application is not authorized on behalf of the first user to invoke with the at least one intent from the second application running on the computing device.

12. The method of claim 10, wherein providing the response comprises:
determining, after validating the user token, from the user-specific authorization policy provisioned for the first user, whether the at least one intent is included in the one or more allowed intents that the first application is authorized to invoke with or accept from the second application running on the computing device; and
when it is determined that the at least one intent is included in the one or more allowed intents that the first application is authorized to invoke with or accept from the second application running on the computing device, including a message in the response to indicate that the first application is authorized on behalf of the first user to invoke with the at least one intent from the second application running on the computing device.

13. The method of claim 12, further comprising:
invoking, by the first application, the at least one intent with the second application in response to the message indicating that the first application is authorized on behalf of the first user to invoke with the at least one intent from the second application running on the computing device.

14. The method of claim 12, wherein the user-specific authorization policy further defines an expiration time after which the user-specific authorization policy provisioned for each respective user is no longer valid, the method further comprising:
determining, at the intent management server, that the expiration time has not expired before providing the response.

15. The method of claim 12, wherein the user-specific authorization policy further identifies one or more particular computing devices for which the user-specific authorization policy is valid, the method further comprising:
retrieving, at the intent management server, from the intent authorization request, a device identifier associated with the computing device running the first and the second applications; and
determining, at the intent management server, that the device identifier is associated with the one or more particular computing devices identified in the user-specific authorization policy before providing the response.

16. The method of claim 12, further comprising:
retrieving, at the intent management server, an application signature from the intent authorization request; and
prior to providing the response, validating, at the intent management server, the application signature by verifying that the application signature is cryptographically signed by the first application intending to interact with the second application.

17. An intent management server, comprising:
a communications interface,
a memory provisioned with a user-specific authorization policy for each respective user from a list of users authorized to access a first application running on a computing device, the user-specific authorization policy identifying one or more allowed intents that the first application is authorized on behalf of the respective user to invoke with or accept from a second application running on the computing device; and
an electronic processor communicatively coupled to the communications interface and the memory, the electronic processor configured to:
receive, via the communications interface, an intent authorization request from the second application intending to interact with the first application on behalf of a first user from the list of users, the intent authorization request from the second application including an user token associated with the first user and information identifying at least one intent that the second application is intending to invoke with the first application;
validate the user token received from the second application by verifying that the first user is authorized to access both the first and second applications running on the computing device; and
provide, via the communications interface, a response to the intent authorization request based on the user-specific authorization policy provisioned for the first user from the list of users, the response indicating whether the second application running on the computing device is authorized on behalf of the first user to invoke the at least one intent with the first application running on the computing device.

18. The intent management server of claim 17, wherein the electronic processor is configured to:
determine, after validating the user token, from the user-specific authorization policy provisioned for the first user, whether the at least one intent is included in the one or more allowed intents that the first application is authorized to accept from the second application running on the computing device; and
when it is determined that the at least one intent is not included in the one or more allowed intents that the first application is authorized to accept from the second application running on the computing device, include a message in the response to indicate that the second application running on the computing device is not authorized on behalf of the first user to invoke the at least one intent with the first application running on the computing device.

19. The intent management server of claim 17, wherein the electronic processor is configured to:
determine, after validating the user token, from the user-specific authorization policy provisioned for the first user, whether the at least one intent is included in the one or more allowed intents that the first application is authorized to accept from the second application running on the computing device; and
when it is determined that the at least one intent is included in the one or more allowed intents that the first application is authorized to accept from the second application running on the computing device, issue, at the intent management server, an intent authorization token with the response to indicate that the second application running on the computing device is authorized on behalf of the first user to invoke the at least one intent with the first application running on the computing device.

20. The intent management server of claim 17, wherein the user-specific authorization policy further defines at least one of:
an expiration time after which the user-specific authorization policy provisioned for each respective user is no longer valid; or
one or more device identifiers identifying particular computing devices for which the user-specific authorization policy is valid.
